(19) United States
(12) Patent Application Publication
(10) Pub. No.: US 2021/0297617 A1
(43) Pub. Date: Sep. 23, 2021

(54) IMAGING WITH AMBIENT LIGHT SUBTRACTION

(71) Applicant: Sony Semiconductor Solutions Corporation, Kanagawa (JP)

(72) Inventor: Noam Eshel, Pardesia (IL)

(21) Appl. No.: 16/822,787

(22) Filed: Mar. 18, 2020

(51) Int. Cl. H04N 5/378; H04N 5/369; H04N 5/3745

(52) U.S. Cl. CPC H04N 5/378; H04N 5/3745; H04N 5/379

(57) ABSTRACT

A time-of-flight image sensor (TOF) for imaging with ambient light subtraction. In one embodiment, the TOF image sensor includes a pixel array including a plurality of pixel circuits, a control circuit, and a signal processing circuit. The signal processing circuit reads out a first data signal from respective floating diffusions during a first frame after a first reset of the respective floating diffusions and after a first integration of respective photoelectric conversion devices while a light generator is in a non-emission state, read out a second data signal from the respective floating diffusions after a second reset and after a second integration of the respective photoelectric conversion devices while the light generator is in an emission state, and generate a third data signal indicative of a light signal emitted by the light generator and reflected off an object.

### BACKGROUND OF THE INVENTION

### 1. Field of the Invention

This application relates generally image sensors. More specifically, this application relates to a time-of-flight image sensor having imaging with ambient light subtraction.

### 2. Description of Related Art

Image sensing devices typically include an image sensor, generally implemented as an array of pixel circuits, as well as signal processing circuitry and any associated control or timing circuitry. Within the image sensor itself, charge is collected in a photoelectric conversion device of the pixel circuit as a result of impinging light. There are typically a very large number of individual photoelectric conversion devices (e.g. tens of millions), and many signal processing circuitry components working in parallel. Various components within the signal processing circuitry are shared by a large number of photoelectric conversion devices; for example, a column or multiple columns of photoelectric conversion devices may share a single analog-to-digital converter (ADC) or sample-and-hold (S/H) circuit.

In photography applications, the outputs of the pixel circuits are used to generate an image. In addition to photography, image sensors are used in a variety of applications which may utilize the collected charge for additional or alternative purposes. For example, in applications such as game machines, autonomous vehicles, telemetry systems, factory inspection, gesture controlled computer input devices, and the like, it may be desirable to detect the depth of various objects in a three-dimensional space and/or detect an amount of light reflected off the various objects in the same three-dimensional space.

Moreover, some image sensors support pixel binning operations. In binning, input pixel values from neighboring pixel circuits are averaged together with or without weights to produce an output pixel value. Binning results in a reduced resolution or pixel count in the output image, and may be utilized so as to permit the image sensor to operate effectively in low light conditions or with reduced power consumption.

### BRIEF SUMMARY OF THE INVENTION

Various aspects of the present disclosure relate to devices, methods, and systems having imaging with ambient light subtraction therein. Specifically, the present disclosure is directed to Frame Double Data Sampling (DDS) that enables the subtraction of ambient light by performing two integrations—one integration with the illumination source off, and a second integration with the illumination source on. Frame DDS processing further separates the illumination signal from ambient light as well as fixed pattern noise due to pixel (mainly source follower offset) and readout electronics. The illumination signal, reflected from the object, may then be used to detect object features.

In one aspect of the present disclosure, a time-of-flight imaging sensor is provided. The time-of-flight imaging sensor includes a pixel array including a plurality of pixel circuits, a control circuit, and a signal processing circuit. Respective pixel circuits of the plurality of pixel circuits individually include a photoelectric conversion device and a floating diffusion. The control circuit configured to control a first reset of respective floating diffusions in the respective pixel circuits and control a second reset of the respective floating diffusions. The signal processing circuit is configured to read out a first data signal from the respective floating diffusions during a first frame, the first frame being after the first reset and after a first integration of respective photoelectric conversion devices in the respective pixel circuits while a light generator is in a non-emission state, read out a second data signal from the respective floating diffusions during a second frame, the second frame being after the second reset and after a second integration of the respective photoelectric conversion devices while the light generator is in an emission state, and generate a third data signal by subtracting the first data signal from the second data signal, the third data signal being indicative of a light signal emitted by the light generator and reflected off an object.

In another aspect of the present disclosure, a method for operating a time-of-flight image sensor is provided. The method includes reading out, with a signal processing circuit, a first data signal from respective floating diffusions of respective pixel circuits from a plurality of pixel circuits during a first frame, the first frame being after a first reset of the respective floating diffusions and after a first integration of respective photoelectric conversion devices of the respective pixel circuits while a light generator is in a non-emission state, wherein each of the respective floating diffusions is electrically connected to only one of the respective photoelectric conversion devices. The method includes reading out, with the signal processing circuit, a second data signal from the respective floating diffusions during a second frame, the second frame being after a second reset of the respective floating diffusions and after a second integration of the respective photoelectric conversion devices while the light generator is in an emission state. The method also includes generating, with the signal processing circuit, a third data signal by subtracting the first data signal from the second data signal, the third data signal being indicative of a light signal emitted by the light generator and reflected off an object.

In yet another aspect of the present disclosure, a system is provided. The system includes a light generator configured to emit a light wave and a time-of-flight image sensor. The time-of-flight imaging sensor includes a pixel array including a plurality of pixel circuits, a control circuit, and a signal processing circuit. Respective pixel circuits of the plurality of pixel circuits individually include a photoelectric conversion device and a floating diffusion. The control circuit configured to control a first reset of respective floating diffusions in the respective pixel circuits, control a second reset of the respective floating diffusions, and control the light generator. The signal processing circuit is configured to read out a first data signal from the respective floating diffusions during a first frame, the first frame being after the first reset and after a first integration of respective photoelectric conversion devices in the respective pixel circuits while a light generator is in a non-emission state, read out a second data signal from the respective floating diffusions during a second frame, the second frame being after the second reset and after a second integration of the respective photoelectric conversion devices while the light generator is in an emission state, and generate a third data signal by subtracting the first data signal from the second data signal, the third data signal being indicative of a light signal emitted by the light generator and reflected off an object.

In this manner, the above aspects of the present disclosure provide for improvements in at least the technical field of object feature detection as well as in related technical fields of imaging, image processing, and the like.

This disclosure can be embodied in various forms, including hardware or circuits controlled by computer-implemented methods, computer program products, computer systems and networks, user interfaces, and application programming interfaces; as well as hardware-implemented methods, signal processing circuits, image sensor circuits, application specific integrated circuits, field programmable gate arrays, and the like. The foregoing summary is intended solely to give a general idea of various aspects of the present disclosure, and does not limit the scope of the disclosure in any way.

### DESCRIPTION OF THE DRAWINGS

These and other more detailed and specific features of various embodiments are more fully disclosed in the following description, reference being had to the accompanying drawings, in which:

FIG. 1 is a diagram illustrating an exemplary time-of-flight (TOF) imaging environment according to various aspects of the present disclosure;

FIG. 2 is a circuit diagram illustrating an exemplary pixel circuit according to various aspects of the present disclosure;

FIG. 3 is a circuit diagram illustrating an exemplary TOF image sensor according to various aspects of the present disclosure;

FIG. 4 is a diagram illustrating an exemplary process for ambient light subtraction according to various aspects of the present disclosure; and

FIG. 5 is a flowchart illustrating a method for operating the exemplary TOF imaging system of FIG. 1.

### DETAILED DESCRIPTION

In the following description, numerous details are set forth, such as flowcharts, data tables, and system configurations. It will be readily apparent to one skilled in the art that these specific details are merely exemplary and not intended to limit the scope of this application.

Moreover, while the present disclosure focuses mainly on examples in which the processing circuits are used in image sensors, it will be understood that this is merely one example of an implementation. It will further be understood that the disclosed, devices, methods, and systems may be used in any device in which there is a need to detect object features (for example, facial detection).

Imaging System

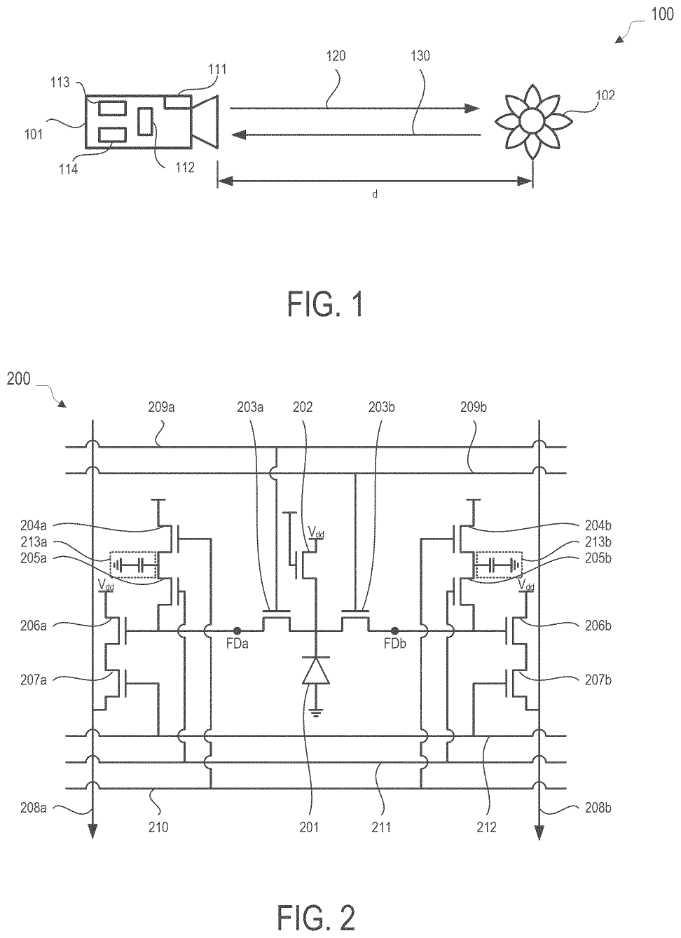

FIG. 1 is a diagram illustrating an exemplary time-of-flight (TOF) imaging environment 100 according to various aspects of the present disclosure. In the example of FIG. 1, the TOF imaging environment 100 includes a TOF imaging system 101 that is configured to image an object 102 located a distance d away. The TOF imaging system 101 includes a light generator 111 configured to generate an emitted light wave 120 toward the object 102 and an image sensor 112 configured to receive a reflected light wave 130 from the object 102. The emitted light wave 120 may have a periodic waveform. The image sensor 112 may be any device capable of converting incident radiation into signals. For example the image sensor may be a Complementary Metal-Oxide Semiconductor (CMOS) Image Sensor (CIS), a Charge-Coupled Device (CCD), and the like. The TOF imaging system 101 may further include distance determination circuitry such as a controller 113 (for example, a microprocessor or other suitable processing device) and a memory 114, which may operate to perform one or more examples of object feature detection processing (e.g., facial detection) and/or time-of-flight processing as described further below. The light generator 111, the image sensor 112, the controller 113, and the memory 114 may be communicatively connected to each other via one or more communication buses.

The light generator 111 may be, for example, a light emitting diode (LED), a laser diode, or any other light generating device or combination of devices, and the light waveform may be controlled by the controller 113. The light generator may operate in the infrared range so as to reduce interference from the visible spectrum of light, although any wavelength range perceivable by the image sensor 112 may be utilized. In some examples, the controller 113 may be configured to receive a light intensity image from the image sensor 112 in which ambient light has been subtracted from the light intensity image, and detect features of the object 102 with the light intensity image. For example, the light intensity image may be an IR or near-IR light intensity image for detection of facial features. Additionally, in some examples, the controller 113 may also be configured to receive a depth image from the image sensor and calculate a depth map indicative of the distance d to various points of the object 102.

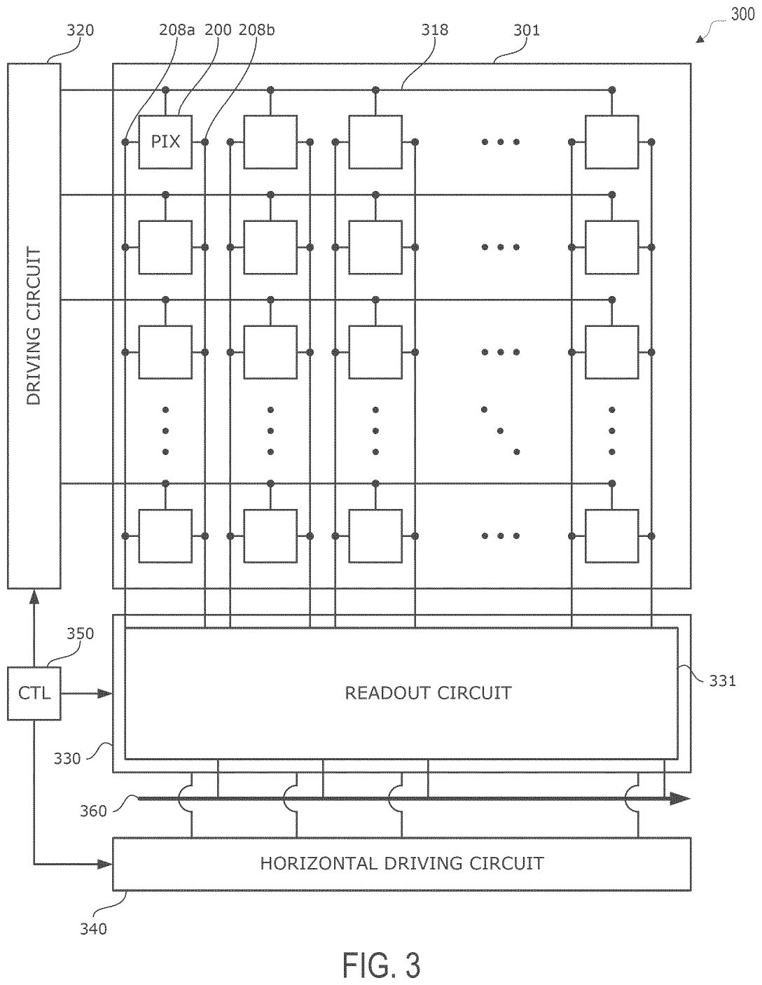

FIG. 2 is a circuit diagram illustrating an exemplary pixel circuit 200 according to various aspects of the present disclosure. As shown in FIG. 2, the pixel circuit 200 includes a photoelectric conversion device 201 (e.g., a photodiode), a pixel reset transistor 202, a first transfer transistor 203a, a second transfer transistor 203b, a first floating diffusion FDa, a second floating diffusion FDb, a first tap reset transistor 204a, a second tap reset transistor 204b, a first intervening transistor 205a, a second intervening transistor 205b, a first amplifier transistor 206a, a second amplifier transistor 206b, a first selection transistor 207a, and a second selection transistor 207b. The photoelectric conversion device 201, the first transfer transistor 203a, the first tap reset transistor 204a, the first intervening transistor 205a, the first amplifier transistor 206a, and the first selection transistor 207a are controlled to output an analog signal (A) via a first vertical signal line 208a, which may be an example of the vertical signal line 313a illustrated in FIG. 3 below. This set of components may be referred to as “Tap A.” The photoelectric conversion device 201, the second transfer transistor 203b, the second tap reset transistor 204b, the second intervening transistor 205b, the second amplifier transistor 206b, and the second selection transistor 207b are controlled to output an analog signal (B) via a second vertical signal line 208b, which may be an example of the vertical signal line 313b illustrated in FIG. 3 below. This set of components may be referred to as “Tap B.”

Additionally, in some examples, the pixel circuit 200 may also include two optional capacitors (optionality illustrated by boxes with dashed lines). The two optional capacitors include a first capacitor 213a and a second capacitor 213b. The first capacitor 213a is included in Tap A and the second capacitor 213b is included in Tap B. The two optional capacitors may be used to maximize the saturation charge by shorting the two optional capacitors to the respective floating diffusions FDa and FDb during charge collection. For example, when the two optional capacitors are included in the pixel circuit 200, the first and second intervening transistors 205a and 205b are ON continuously, and the first and second tap reset transistors 204a and 204b control the operation of the pixel circuit 200. However, when the two optional capacitors are not included in the pixel circuit 200, the first and second intervening transistors and the first and second tap reset transistors 204a and 204b are ON continuously, and the first and second intervening transistors 205a and 205b control the operation of the pixel circuit 200.

The first transfer transistor 203a and the second transfer transistor 203b are controlled by control signals on a first transfer gate line 209a and a second transfer gate line 209b, respectively. The first tap reset transistor 204a and the second tap reset transistor 204b are controlled by a control signal on a tap reset gate line 210. The first intervening transistor 205a and the second intervening transistor 205b are controlled by a control signal on a FD gate line 211. The first selection transistor 207a and the second selection transistor 207b are controlled by a control signal on a selection gate line 212. The first and second transfer gate lines 209a and 209b, the tap reset gate line 210, the FD gate line 211, and the selection gate line 212 may be examples of the horizontal signal lines 312 illustrated in FIG. 3 below.

In operation, the pixel circuit 200 may be controlled in a time-divisional manner such that, during a first half of a horizontal period, incident light is converted via Tap A to generate the output signal A; and, during a second half of the horizontal period, incident light is converted via Tap B to generate the output signal B.

During a light intensity imaging mode, the control signals with respect to the first transfer gate line 209a and the second transfer gate line 209b turn ON the first transfer transistor 203a and the second transfer transistor 203b and maintain the ON state of the first transfer transistor 203a and the second transfer transistor 203b for a predetermined period of time. During a depth imaging mode, the control signals with respect to the first transfer gate line 209a and the second transfer gate line 209b turn ON and OFF the first transfer transistor 203a and the second transfer transistor 203b at a specific modulation frequency.

While FIG. 2 illustrates the pixel circuit 200 having a plurality of transistors in a particular configuration, the current disclosure is not so limited and may apply to a configuration in which the pixel circuit 200 includes fewer or more transistors as well as other elements, such as additional capacitors (e.g., the two optional capacitors), resistors, and the like.

FIG. 3 is a circuit diagram illustrating an exemplary TOF image sensor 300 according to various aspects of the present disclosure. The TOF image sensor 300 includes an array 301 of the pixel circuits 200 as described above and illustrated in FIG. 2. The pixel circuits 200 are located at intersections where horizontal signal lines 318 and vertical signal lines 208a and 208b cross one another. The horizontal signal lines 318 are operatively connected to a vertical driving circuit 220, also known as a “row scanning circuit,” at a point outside of the pixel array 301, and carry signals from the vertical driving circuit 320 to a particular row of the pixel circuits 200. Pixels in a particular column output analog signals corresponding to respective amounts of incident light to the vertical signal line 208a and 208b. For illustration purposes, only a subset of the pixel circuits 200 are actually shown in FIG. 3; however, in practice the image sensor 300 may have up to tens of millions of pixel circuits (“megapixels” or MP) or more.

The vertical signal lines 208a and 208b conduct the analog signals for a particular column to a column circuit 330, also known as a “signal processing circuit.” Moreover, while FIG. 3 illustrates a single readout circuit 331 for all columns, the image sensor 300 may utilize a plurality of readout circuits 331. The analog electrical signals generated in photoelectric conversion device 201 in the pixel circuit 200 is retrieved by the readout circuit 231 and is then converted to digital values. Such a conversion typically requires several circuit components such as sample-and-hold (S/H) circuits, analog-to-digital converters (ADCs), and timing and control circuits, with each circuit component serving a purpose in the conversion. For example, the purpose of the S/H circuit may be to sample the analog signals from different time phases of the photodiode operation, after which the analog signals may be converted to digital form by the ADC.

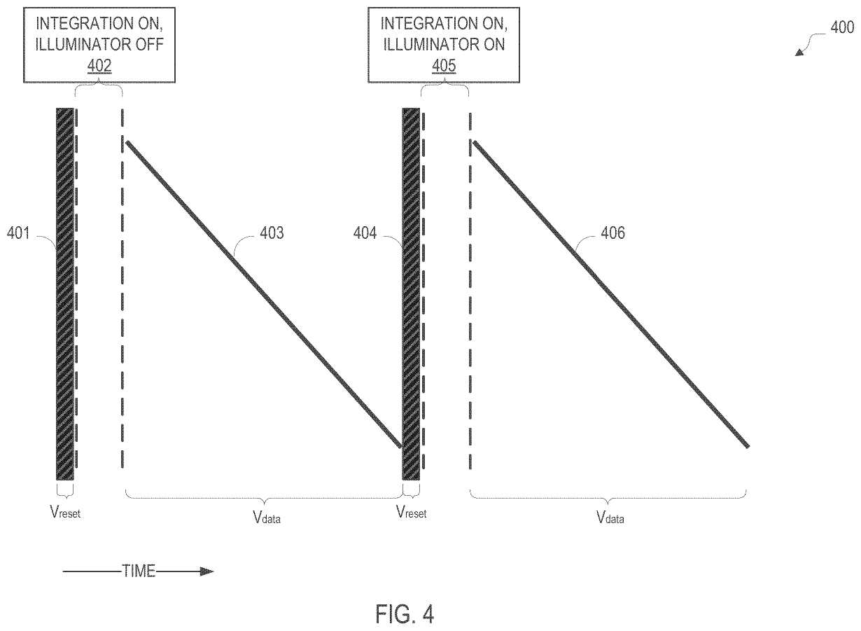

The signal processing circuit may perform Frame DDS operations as described below in FIG. 4. In some examples, the Frame DDS processing is performed individually with respect to tap A and tap B. However, in other examples, the two digital outputs from the Frame DDS processing described below may be added together by the signal processing circuit to increase the signal-to-noise ratio (SNR).

FIG. 4 is a diagram illustrating an exemplary process 400 for ambient light subtraction according to various aspects of the present disclosure. As illustrated in FIG. 4, the readout circuit 331 may perform the subtraction process 400 of frame double data sampling (also referred to as “Frame DDS”). Frame DDS also overcomes some pixel noise related issues by sampling each pixel circuit 200 twice. First, a first reset voltage Vᵣₑₛₑₜ 401 is applied to each pixel circuit 200 to reset the FD. After the first reset voltage Vᵣₑₛₑₜ 401 is applied, a first integration 402 of the FD is performed with the illuminator in a non-emission state. After the first integration 402 of the FD, a first data voltage V_{data} 403 of each pixel circuit 200 (that is, the voltage after each pixel circuit 200 has been exposed to light) is sampled and output as a first data signal. After the first V_{data} 403 sampling, a second reset voltage Vᵣₑₛₑₜ 404 is applied to each pixel circuit 200 to reset each pixel circuit 200. After the second reset voltage Vᵣₑₛₑₜ 404 is applied, a second integration 405 of the FD is performed with the illuminator in an emission state. After the second integration 405 of the FD, a second data voltage V_{data} 406 of each pixel circuit 200 is sampled and output as a second data signal.

In the Frame DDS, the first data voltage V_{data} 403 (i.e., the first data signal sampled during a first frame) is generally equal to ambient light and the second data voltage V_{data} 406 (i.e., the second data signal sampled during a second frame) is equal to ambient light and a reflected light signal from the object. Frame DDS is defined by the following expression:

Frame 2−Frame 1=ΔA=(Signal(a2)+ambient(a2))−ambient(a1) (1)

In the above expression, frame 2 is the second data signal and frame 1 is the first data signal. Additionally, in the above expression, signal(a) is indicative of the light signal emitted by a light generator and reflected from an object, ambient(a2) is the ambient light associated with frame 2, and ambient(a1) is the ambient light associated with frame 1. Put simply, the first data signal is subtracted from the second data signal to output a third data signal that is indicative of a light signal reflected from an object, the light signal generated by a light generator. The Frame DDS also reduces or eliminates the fixed pattern noise between frame 2 and frame 1 along with the ambient light subtraction.

The column circuit 330 is controlled by a horizontal driving circuit 340, also known as a “column scanning circuit.” Each of the vertical driving circuit 320, the column circuit 330, and the horizontal driving circuit 340 receive one or more clock signals from a controller 350. The controller 350 controls the timing and operation of various image sensor components such that analog signals from the pixel array 301, having been converted to digital signals in the column circuit 330, are output via an output circuit 360 for signal processing, storage, transmission, and the like. In some examples, the controller 350 may be similar to the controller 113 as described above in FIG. 1.

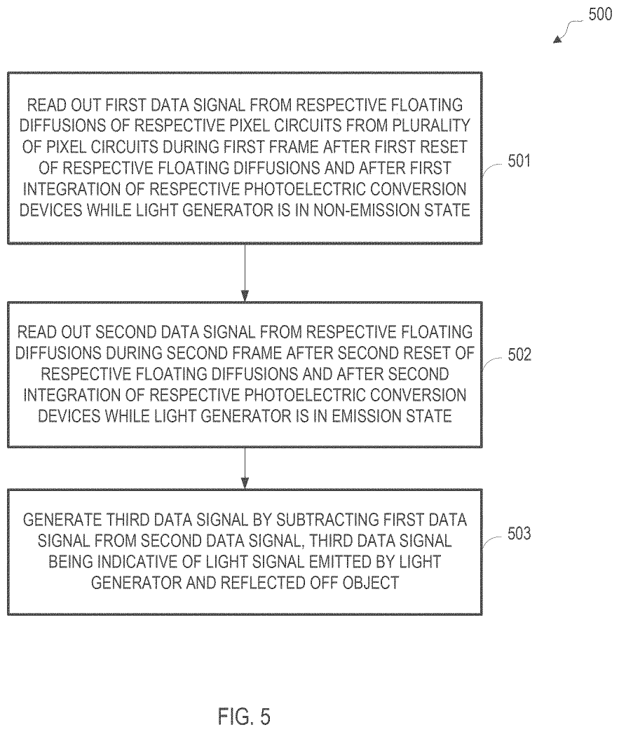

FIG. 5 is a flowchart illustrating a method 500 for operating a TOF imaging sensor according to various aspects of the present disclosure. The method 500 includes reading out, with a signal processing circuit, a first data signal from respective floating diffusions of respective pixel circuits from a plurality of pixel circuits during a first frame, the first frame being after a first reset of the respective floating diffusions and after a first integration of respective photoelectric conversion devices of the respective pixel circuits while a light generator is in a non-emission state, wherein each of the respective floating diffusions is electrically connected to only one of the respective photoelectric conversion devices (at block 501). For example, the readout circuit 331 reads out a first data signal 403a from respective floating diffusions FD of respective pixel circuits 200 from a plurality of pixel circuits during a first frame, the first frame being after a first reset 401 of the respective floating diffusions FD and after a first integration 402 of respective photoelectric conversion devices 201 of the respective pixel circuits 200 while a light generator is in a non-emission state, wherein each of the respective floating diffusions FD is electrically connected to only one of the respective photoelectric conversion devices FD (at block 501). The first data signal is indicative of ambient light (including fixed pattern noise) during the first frame.

The method 500 includes reading out, with the signal processing circuit, a second data signal from the respective floating diffusions during a second frame, the second frame being after a second reset of the respective floating diffusions and after a second integration of the respective photoelectric conversion devices while the light generator is in an emission state (at block 502). For example, the readout circuit 331 reads out a second data signal 406a from the respective floating diffusions FD during a second frame, the second frame being after a second reset 404 of the respective floating diffusions and after a second integration 405 of the respective photoelectric conversion devices while the light generator is in an emission state. The second data signal is indicative of ambient light (including fixed pattern noise) and a light signal emitted by the light generator 111 and reflected of an object 102 during the second frame.

The method 500 includes generating, with the signal processing circuit, a third data signal by subtracting the first data signal from the second data signal, the third data signal being indicative of a light signal emitted by the light generator and reflected off an object (at block 503). For example, the readout circuit 331 generates a third data signal by subtracting the first data signal from the second data signal, the third data signal being indicative of a light signal emitted by the light generator 111 and reflected off an object 102.

In some examples, the method 500 may further include outputting, with the signal processing circuit, the third data signal for light intensity image processing. In other examples, the method 500 may further include performing, with the signal processing circuit, light intensity image processing on the third data signal.

In some examples, the respective photoelectric conversion devices 201 may be electrically connected to respective first taps 203a and respective second taps 203b, the respective first taps 203a include the respective floating diffusions as first respective floating diffusions FDa, and the respective second taps include second respective floating diffusions FDb. In these examples, the method 500 further includes the readout circuit 331 reading out a fourth data signal 403b from the second respective floating diffusions FDb during a third frame, the third frame being after a third reset 401 of the second respective floating diffusions FDb and after a third integration 402 of the respective photoelectric conversion devices 201 while the light generator is in a non-emission state, reading out a fifth data signal 406b from the second respective floating diffusions FDb during a fourth frame, the fourth frame being after a fourth reset 404 of the second respective floating diffusions FDb and after a fourth integration 405 of the respective photoelectric conversion devices 201 while the light generator is in an emission state, and generating a sixth data signal by subtracting the fourth data signal from the fifth data signal, the sixth data signal being indicative of the light signal emitted by the light generator and reflected off the object 102.

The fourth data signal is indicative of ambient light (including fixed pattern noise) during the third frame. The fifth data signal is indicative of ambient light (including fixed pattern noise) and a light signal emitted by the light generator 111 and reflected of an object 102 during the fourth frame.

Additionally, in some examples, the method 500 may further include the readout circuit 331 generating a seventh data signal by adding together the third data signal and the sixth data signal, the seventh data signal being indicative of two light signals emitted by the light generator and reflected off the object, and outputting the seventh data signal for light intensity image processing.

In some examples, the method 500 may include the readout circuit 331 reading out the first data signal from the respective floating diffusions in parallel to reading out the fourth data signal from the second respective floating diffusions. Alternatively, in other examples, the method 500 may include the readout circuit 331 reading out the first data signal from the respective floating diffusions not in parallel to reading out the fourth data signal from the second respective floating diffusions.

In some examples, the method 500 may include the readout circuit 331 reading out the second data signal from the respective floating diffusions in parallel to reading out the fifth data signal from the second respective floating diffusions. Alternatively, in other examples, the method 500 may include the readout circuit 331 reading out the second data signal from the respective floating diffusions not in parallel to reading out the fifth data signal from the second respective floating diffusions.

### CONCLUSION

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A time-of-flight image sensor comprising:
a pixel array including a plurality of pixel circuits, respective pixel circuits of the plurality of pixel circuits individually including
a photoelectric conversion device, and
a floating diffusion;
a control circuit configured to
control a first reset of respective floating diffusions in the respective pixel circuits, and
control a second reset of the respective floating diffusions; and
a signal processing circuit configured to
read out a first data signal from the respective floating diffusions during a first frame, the first frame being after the first reset and after a first integration of respective photoelectric conversion devices in the respective pixel circuits while a light generator is in a non-emission state,
read out a second data signal from the respective floating diffusions during a second frame, the second frame being after the second reset and after a second integration of the respective photoelectric conversion devices while the light generator is in an emission state, and
generate a third data signal by subtracting the first data signal from the second data signal, the third data signal being indicative of a light signal emitted by the light generator and reflected off an object.

2. The time-of-flight image sensor according to claim 1, wherein the respective photoelectric conversion devices are electrically connected to respective first taps and respective second taps opposite to the respective first taps, and wherein the respective first taps include the respective floating diffusions as first respective floating diffusions.

3. The time-of-flight image sensor according to claim 2, wherein the respective second taps include second respective floating diffusions, wherein the control circuit is further configured to control a third reset of the second floating diffusion and control a fourth reset of the second floating diffusion, and wherein the signal processing circuit is further configured to
read out a fourth data signal from the second respective floating diffusions during a third frame, the third frame being after the third reset and after a third integration of the respective photoelectric conversion devices while the light generator is in a non-emission state,
read out a fifth data signal from the second respective floating diffusions during a fourth frame, the fourth frame being after the fourth reset and after a fourth integration of the respective photoelectric conversion devices while the light generator is in an emission state,
generate a sixth data signal by subtracting the fourth data signal from the fifth data signal, the sixth data signal being indicative of the light signal emitted by the light generator and reflected off the object.

4. The time-of-flight image sensor according to claim 3, wherein the signal processing circuit is further configured to
generate a seventh data signal by adding together the third data signal and the sixth data signal, the seventh data signal being indicative of two light signals emitted by the light generator and reflected off the object, and
output the seventh data signal.

5. The time-of-flight image sensor according to claim 3, wherein the read out of the first data signal from the respective floating diffusions is in parallel to the read out of the fourth data signal from the second respective floating diffusions.

6. The time-of-flight image sensor according to claim 3, wherein the read out of the first data signal from the respective floating diffusions is not in parallel to the read out of the fourth data signal from the second respective floating diffusions.

7. The time-of-flight image sensor according to claim 3, wherein the read out of the second data signal from the respective floating diffusions is in parallel to the read out of the fifth data signal from the second respective floating diffusions.

8. The time-of-flight image sensor according to claim 3, wherein the read out of the second data signal from the respective floating diffusions is not in parallel to the read out of the fifth data signal from the second respective floating diffusions.

9. A method for operating a time-of-flight image sensor, the method comprising:
reading out, with a signal processing circuit, a first data signal from respective floating diffusions of respective pixel circuits from a plurality of pixel circuits during a first frame, the first frame being after a first reset of the respective floating diffusions and after a first integration of respective photoelectric conversion devices of the respective pixel circuits while a light generator is in a non-emission state, wherein each of the respective floating diffusions is electrically connected to only one of the respective photoelectric conversion devices;
reading out, with the signal processing circuit, a second data signal from the respective floating diffusions during a second frame, the second frame being after a second reset of the respective floating diffusions and after a second integration of the respective photoelectric conversion devices while the light generator is in an emission state; and
generating, with the signal processing circuit, a third data signal by subtracting the first data signal from the second data signal, the third data signal being indicative of a light signal emitted by the light generator and reflected off an object.

10. The method to claim 9, wherein the respective photoelectric conversion devices are electrically connected to respective first taps and respective second taps, wherein the respective first taps include the respective floating diffusions as first respective floating diffusions, and wherein the respective second taps include second respective floating diffusions, the method further comprising:
reading out, with the signal processing circuit, a fourth data signal from the second respective floating diffusions during a third frame, the third frame being after a third reset of the second respective floating diffusions and after a third integration of the respective photoelectric conversion devices while the light generator is in a non-emission state;
reading out, with the signal processing circuit, a fifth data signal from the second respective floating diffusions during a fourth frame, the fourth frame being after a fourth reset of the second respective floating diffusions and after a fourth integration of the respective photoelectric conversion devices while the light generator is in an emission state; and
generating, with the signal processing circuit, a sixth data signal by subtracting the fourth data signal from the fifth data signal, the sixth data signal being indicative of the light signal emitted by the light generator and reflected off the object.

11. The method according to claim 10, further comprising:
generating, with the signal processing circuit, a seventh data signal by adding together the third data signal and the sixth data signal, the seventh data signal being indicative of two light signals emitted by the light generator and reflected off the object; and
outputting, with the signal processing circuit, the seventh data signal.

12. The method according to claim 10, wherein reading out the first data signal from the respective floating diffusions is in parallel to reading out the fourth data signal from the second respective floating diffusions.

13. The method according to claim 10, wherein reading out the first data signal from the respective floating diffusions is not in parallel to reading out the fourth data signal from the second respective floating diffusions.

14. The method according to claim 10, wherein reading out the second data signal from the respective floating diffusions is in parallel to reading out the fifth data signal from the second respective floating diffusions.

15. The method according to claim 10, wherein reading out the second data signal from the respective floating diffusions is not in parallel to reading out the fifth data signal from the second respective floating diffusions.

16. A system comprising:
a light generator configured to emit a light wave; and
a time-of-flight image sensor including a pixel array including a plurality of pixel circuits, respective pixel circuits of the plurality of pixel circuits individually including
a photoelectric conversion device, and
a floating diffusion;
a control circuit configured to
control a first reset of respective floating diffusions in the respective pixel circuits,
control a second reset of the respective floating diffusions, and
control the light generator; and
a signal processing circuit configured to
read out a first data signal from the respective floating diffusions during a first frame, the first frame being after the first reset and after a first integration of respective photoelectric conversion devices in the respective pixel circuits while a light generator is in a non-emission state,
read out a second data signal from the respective floating diffusions during a second frame, the second frame being after the second reset and after a second integration of the respective photoelectric conversion devices while the light generator is in an emission state,
generate a third data signal by subtracting the first data signal from the second data signal, the third data signal being indicative of a light signal emitted by the light generator and reflected off an object.

17. The system according to claim 16, wherein the respective photoelectric conversion devices are electrically connected to respective first taps and respective second taps opposite to the respective first taps, and wherein the respective first taps include the respective floating diffusions as first respective floating diffusions.

18. The system according to claim 17, wherein the respective second taps include second respective floating diffusions, wherein the control circuit is further configured to control a third reset of the second floating diffusion and control a fourth reset of the second floating diffusion, and wherein the signal processing circuit is further configured to
read out a fourth data signal from the second respective floating diffusions during a third frame, the third frame being after the third reset and after a third integration of the respective photoelectric conversion devices while the light generator is in a non-emission state,
read out a fifth data signal from the second respective floating diffusions during a fourth frame, the fourth frame being after the fourth reset and after a fourth integration of the respective photoelectric conversion devices while the light generator is in an emission state,
generate a sixth data signal by subtracting the fourth data signal from the fifth data signal, the sixth data signal being indicative of the light signal emitted by the light generator and reflected off the object.

19. The system according to claim 18, wherein the signal processing circuit is further configured to
generate a seventh data signal by adding together the third data signal and the sixth data signal, the seventh data signal being indicative of two light signals emitted by the light generator and reflected off the object, and
output the seventh data signal.

20. The system according to claim 18, wherein the read out of the first data signal from the respective floating diffusions is in parallel to the read out of the fourth data signal from the second respective floating diffusions.
